(19) United States
(12) Patent Application Publication
(10) Pub. No.: US 2003/0209489 A1
(43) Pub. Date: Nov. 13, 2003

(54) System and method for remediation of waste

(76) Inventors: Daryl W. Haerther, Strasburg, CO (US); Donald Ian Rosebrook, Englewood, CO (US); Loren L. Losh, Strasburg, CO (US)

Correspondence Address: SHERIDAN ROSS PC, 1560 BROADWAY, SUITE 1200, DENVER, CO, 80202

(21) Appl. No.: 10/158,562

(22) Filed: May 29, 2002

Related U.S. Application Data
(60) Provisional application No. 60/378,754, filed on May 7, 2002.
(60) Provisional application No. 60/379,563, filed on May 10, 2002.

(51) Int. Cl. C02F 3/32

(52) U.S. Cl. 210/602; 210/209

(57) ABSTRACT

A system and method are provided for aerobic treatment of waste, such as animal or human waste. The method includes the continual introduction of a particular species/strain of chlorella algae into the waste site. The high amounts of oxygen produced by the microalgae satisfies the biochemical oxygen demand in the treatment process and also allows oxidation of undesirable contaminants. Delivery of the microalgae at a desired rate is achieved by incorporation of a series of electrical and mechanical devices housed within a greenhouse type structure which optimizes growth conditions for the microalgae, and also allows the system to be automated.

### CROSS-REFERENCE TO RELATED APPLICATIONS

This application claims the benefit of priority under 35 U.S.C. §119(e) from U.S. Provisional Application Serial No. 60/378,754 by Haerther et al., filed May 7, 2002, entitled “SYSTEM AND METHOD FOR REMEDIATION OF WASTE”, which is incorporated herein by reference in its entirety. This application also claims the benefit of priority under 35 U.S.C. §119(e) from U.S. Provisional Application Serial No. 60/379,563 by Rosebrook, filed May 10, 2002, entitled “MICROORGANISM FOR REMEDIATION OF WASTE AND METHOD OF CULTURING THE SAME”, which is incorporated herein by reference in its entirety.

### FIELD OF THE INVENTION

This invention relates to a system and method for remediating waste, and more particularly, to a system and method for the aerobic biodegradation of animal and human waste stored in waste ponds and other similar facilities.

### BACKGROUND OF THE INVENTION

The last decade has witnessed a change in the production of livestock and dairy products from small, family owned units, to large corporate owned farms. As a direct result of this evolution, large wastewater ponds have been constructed to consolidate waste handling and remediation. However, the increased production of these large farms has also resulted in increased waste which directly impacts air and water quality in the surrounding area.

Because of economic constraints, livestock production units typically utilize large anaerobic earthen or concrete storage basins. These large basins ponds can be sources of air and water pollution. Anaerobic decomposition produces carbon dioxide, methane, (one of the greenhouse gases); hydrogen sulfide, (of concern because of its toxicity and odor); and ammonia. The smell of nearby manure decomposition is particularly offensive, and has created concerns throughout the livestock and dairy industry.

The impact of an organic waste discharged into a stream, lake, or underground aquifer can be predicted by the measurement of dissolved oxygen (DO), ammonia nitrogen (NH3-N), and biological chemical oxygen demand (BOD) in the waste water source. Livestock waste streams typically have BOD concentrations in excess of 5000 mg/L compared with approximately 200 mg/L for municipal wastewater. The high BOD levels of livestock waste prohibit any discharge into receiving streams by livestock and dairy production units. Municipalities are regulated by state and federal permit standards as to the BOD and NH3-N limits allowed to be discharged into receiving streams. Liquid manure tends to have the majority of its nitrogen in the ammonia form (NH3-N).

In anaerobic storage and decomposition, organic nitrogen is continually being converted to ammonia and a portion of the ammonia is volatilized and therefore lost to the atmosphere, contributing to both odor and to nitrogen enrichment of surface waters. Excess ammonia levels in water presents health problems for humans as well as animals by reducing the oxygen carrying capacity of blood. If ground water becomes contaminated, it is likely that several years will be required for the aquifer to recover.

Federal secondary effluent criteria for publicly owned treatment facilities do not include dissolved oxygen minimums. Yet, there are local discharge requirements that specify a minimum DO concentration ranging from 2 to 8 mg/L, depending on surrounding stream requirements. Generally, DO concentration levels of 2 to 4 mg/L are desirable for secondary effluents, while DO concentrations of 6 to 8 mg/L might be needed for more advanced waste systems. In order to meet these DO requirements and to aid in waste remediation, mechanical aeration equipment is used, primarily in municipal waste water facilities.

Mechanical aeration equipment is expensive to purchase, install, maintain and operate. The energy costs alone make most aeration equipment infeasible for use in agricultural operations. Obviously, there is an urgent need for an economically affordable aerobic treatment method for wastewater treatment and storage facilities.

The purpose of a mechanical aeration system is to produce the oxygen that may be used either to satisfy the BOD in biological treatment processes or to act as an agent in the oxidation of undesirable contaminants. However, mechanical aeration systems are limited in their ability to increase dissolved oxygen above certain levels.

Aerobic treatment is common in the municipal wastewater field, but, due to the high costs involved in maintaining an adequate oxygen supply, most livestock producers have selected and utilized anaerobic treatment options. Today, aerobic treatment, particularly for livestock operations, is viewed primarily as a potential supplement to anaerobic digestion for reducing odor and ammonia volatilization.

Aerobic treatment of waste can be achieved through use of a microbial agent (i.e., a microbe) whereby microbes use dissolved and suspended organic matter as a source of food. These microbes produce oxygen as a byproduct of photosynthesis, along with other byproducts which may or may not be desirable in achieving waste remediation.

There are a number of disadvantages in current aerobic treatment methods. One current disadvantage is that many of the microbes utilized are particularly sensitive to temperature and light conditions, and such microbes only flourish in optimum light and temperature conditions. Particularly in less temperate zones where there are greater variations in daily temperature highs and lows, most microbes do not flourish, particularly in the colder winter months. Accordingly, the rate at which waste is remediated greatly drops off during the winter months. Another factor which presently limits most aerobic treatment processes is that there must be certain existing levels of dissolved oxygen and water to be available in order for the micro-organisms to be metabolically active. Particularly in agricultural operations, the waste ponds often have a thick hard and dry upper crust which carries little or no oxygen and water. Subsequently, aerobic treatment for these types of waste situations is very inefficient. Another factor which limits the effectiveness of current aerobic processes is that many microbe species are unable to effectively adapt to new environments, and the wastes which the microbes encounter may not be optimum for sufficient growth of the microbes.

A number of prior art references disclose various systems and methods for remediation of human and animal waste.

U.S. Pat. No. 5,447,850 discloses a method of producing methane from organic waste. The method includes the use of aerobic microorganisms which are inoculated in the waste. The waste is then fermented with the aerobic microorganisms. The waste is also inoculated with anaerobic microorganisms. The waste is placed in an oxygen free environment, and methane is then evolved from the waste.

U.S. Pat. No. 5,755,852 discloses a nutrient rich humus material produced by a process wherein solids in an aqueous slurry of animal excrement are settled or precipitated in a solids ecoreactor, the slurry being treatable before and/or after settlement in the ecoreactor by passing to a bioreactor wherein phosphorus may be precipitated with metallic salts. Aerobic and non-aerobic treatment is used for the slurry to form an active biomass that bioconverts remaining phosphorus, nitrogen and organics. The slurry is recycled to the solids ecoreactor and/or is discharged. At least a portion of the slurry is bioconverted and recovered as a humus material.

U.S. Pat. No. 5,277,814 discloses a process for treating organic wastes. The process may be conducted in a closed reactor with controls to prevent adverse environmental impacts. The process includes mixing wastes with inert bulking agents. An oxygen containing gas is passed through the reaction mixture to assist in removal of excess water from the waste to form a wetted high solids content reaction mixture containing the waste solids mixed with the bulking agent. Aerobic reaction conditions are employed to convert the wastes to a treated waste. The aerobic reaction contemplated within this process utilizes various bacterium.

U.S. Pat. No. 5,472,472 is a related patent to the '852 patent discussed above and discloses the same invention.

U.S. Pat. No. 6,329,196 discloses a biological process enhanced by a method and apparatus used to contact a biomass with a gas and with a nutrient liquid. A compressible porous matrix system containing the biomass is mounted in a reaction vessel containing a body of the nutrient liquid and a body of the gas above the body of the liquid. The liquid has an upper surface exposed to the body of gas defining a liquid gas interface. The compressible porous matrix system is partly immersed in the liquid and extends partly above the upper surface of the liquid. The system is rotated about a horizontal axis such that there is periodic compression and expansion of regions of the porous matrix system without significant loss to the biomass.

U.S. Pat. No. 6,325,934 discloses an enzyme and bacterial combination in a slowly dissolvable matrix for septic tanks, grease traps and waste treatments. Sewage waste bacteria and enzymes are incorporated into a slow release material and delivered to the site of the waste to digest the solid waste. The slow release material is heavy so that the enzymes and bacteria will be delivered to the sludge in the bottom of the sewage digester chamber and are fat soluble so that the enzymes and bacteria will be delivered to the grease to be digested. The delivery system prevents enzymes and bacteria from being diluted in grey water which would otherwise render them less effective and would cause them to be discharged from the sewage system.

U.S. Pat. No. 6,281,001 discloses a process for composting of organic materials and for bioremediation of soils. The composting is conducted in a sealed container. The composition of the organic material is adjusted to a compostable mixture. The adjustment is done by adjusting the organic material and by mixing the organic material with a bulking agent and an inoculant. The method includes monitoring and adjusting the conditions of the composting mixture to maintain conditions within preselected limits.

U.S. Pat. No. 6,277,279 discloses a method for treating waste water by promoting growth of particular microbes capable of degrading undesirable organic material in the waste water. The method includes applying a composition that comprises fatty acids which are shown to provide greater microbial degradation. The fatty acids are preferably a combination of one or more saturated and unsaturated fatty acids. Because the unsaturated fatty acids can be in the liquid phase at room temperature, it is preferred to provide the combination of saturated and unsaturated fatty acids together to form a solid particulate at room temperature and to remain at a solid even at elevated outdoor temperatures.

U.S. Pat. No. 5,904,851 discloses a process for oxygenating a liquid. This particular invention contemplates the use of an aerobic process by carrying out a chemical or microbiological reaction in the oxygen enriched water. The invention further contemplates a therapeutic process of carrying out a treatment of the liquid with an agent containing the oxygen enriched liquid as a vehicle.

U.S. Pat. No. 5,622,864 discloses an apparatus for remediating contaminated soil containing organic compounds. More particularly, this invention is directed towards remediation of soil contaminated with hydrocarbons. The contaminated soil is placed within a container and covered by a pool of recirculating water carrying selected biological elements and chemicals to affect the remediation process.

U.S. Pat. No. 6,146,507 discloses a manure slurry pre-treatment apparatus and method for pre-treating manure. The primary purpose of the method is to alter the gas production which occurs during subsequent treatment within a manure pond. The method primarily contemplates the use of a pre-treatment zone in which the manure slurry is subjected to an alternating electrical current.

U.S. Pat. No. 5,716,523 discloses methods and compositions for treating onsite animal waste pits in order to soften the fluidized hardened solid wastes therein. The method utilizes a particular type of bacteria for the treatment.

U.S. Pat. No. 5,627,069 is a related patent to the above '523 patent and also discloses the same invention in which particular strains of bacteria are used for remediation of the waste pits.

U.S. Pat. No. 4,316,961 discloses a process for production of methane gas by anaerobic digestion of plant material and organic waste.

U.S. Pat. No. 4,432,869 discloses a method of treating animal waste which includes use of an algae/bacteria mixture culture in a separate stage. The pH-value of the algae/bacteria mixture culture is controlled in such a way that a multiplication of rotifers in this stage is inhibited or precluded. The algae/bacteria mixture culture preferably occurs in shallow open air ponds for a period of time. The hold time of the algae/bacteria suspension which is in the rotifer container is adjusted to a pH of 6-8 and can range from two to four days. The single figure in this patent illustrates the basic method. The specific algae contemplated for use in this invention includes various species of chlorella or scenedesmus.

U.S. Pat. No. 6,214,617 discloses a centrifugal fermentation process in which living cells or subcellular biocatalysts are immobilized by opposition of forces. The immobilized cells or biocatalysts may be attached to support complexes that add to the resultant vector forces. The invention can also be viewed as a method of removing contaminants from liquid comprising a biocatalyst in at least one chamber in a centrifugal force field wherein a continuous flow of liquid acts to create a force which opposes the centrifugal force field and wherein a gravitational force contributes to the resultant vector summation of all forces acting on the biocatalyst. The gravitational force, the centrifugal force and opposing liquid force substantially immobilize the biocatalyst. One of the biocatalyst includes algae cells.

U.S. Pat. No. 5,744,041 discloses a method for the step-wise reduction of biological oxygen demand of a waste material having a high concentration of organic waste. The method includes the steps of providing waste material having a biological oxygen demand and allowing the waste material to separate into a liquid fraction including water and organic waste, and allowing at least a portion of the organic waste to be anaerobically digested by microorganisms occurring in the waste. A portion of the liquid fraction having the reduced biological oxygen demand in relation to the oxygen demand of the waste material is removed and mixed with aerobic microorganisms and an aerating gas and allowing at least a portion of the organic waste to be aerobically digested by the aerobic microorganisms to form a liquor including water and suspended solids. Then, a portion of the suspended solids in the liquor is allowed to settle, forming a clarified liquor having a reduced biological oxygen demand relative to the oxygen demand of the liquor. The clarified liquor is subjected to microzone organisms from the clarified liquor to form a permeate having a reduced biological oxygen demand relative to the clarified liquid. Finally, at least a portion of the permeate is discharged or reused. In one embodiment of the process, the aerobic microorganisms comprise green algae of the genus Chlorella.

Although these references may be adequate for their intended purposes, there still exists a need for a system and method for remediation of wastes that incorporates the use of a highly efficient microbe capable of producing large amounts of oxygen, is adaptable to various environmental conditions, and can be delivered to the waste site at a minimum cost. There is also a need for an aerobic system and method of remediation incorporating a microbe which reproduces at a high rate, thus increasing the efficiency of aerobic treatment.

### SUMMARY OF THE INVENTION

In accordance with the present invention, a system and method are provided for remediation of waste which provides an efficient and cost-effective solution through incorporation of a microbe which produces high amounts of oxygen. The invention also incorporates use of a simple mechanical and electrical system which is used to optimize growth of the microbial culture and to deliver the culture to a waste site.

The invention provides high levels of oxygen to targeted waste areas, such as waste water ponds, and remediation takes place through an aerobic process. A microbe in the form of a particular strain or species of a microalgae (e.g., Chlorella algae) is used for the remediation. The system includes a structure and supporting equipment in order to maximize the growth of the microorganisms so the culture can be delivered to a waste site upon demand and over an extended period of time.

One object of the invention is to provide a cost effective yet efficient aerobic remediation process which can handle high levels of human or animal waste.

It is another object of the invention to provide a system that can be customized to treat human and livestock waste on both a small and large scale.

It is yet another object of the invention to provide a system that is adaptable to and effective in a wide range of geographical and climatic conditions.

It is yet another object of the invention to provide an aerobic remediation solution which does not involve the use of potentially hazardous chemicals or processes within the remediation process thereby making the invention an environmentally friendly solution to remediating waste.

The method and system of the invention provides for aerobic remediation of waste by the introduction of one or more species or strains of a microalgae, preferably those denoted herein as Chlorella sp., strain rosebrookii AgSmart 100 (AG-SMART 100 ATCC No. ______), Chlorella sp., strain rosebrookii AgSmart 200 (AG-SMART 200 ATCC No. ______) (previously referred to as Chlorella sp., strain rosebrookii AgSmart 100.1 in U.S. Provisional Application Serial No. 60/379,563 by Rosebrook, supra), or progeny derived from any of these microalgae, to targeted waste areas wherein the microalgae consumes the waste as a food source and high levels of oxygen are produced bu the microalgae during photosynthesis. Chlorella sp., strain rosebrookii AgSmart 100 (AG-SMART 100 ATCC No. ______) and Chlorella sp., strain rosebrookii AgSmart 200 (AG-SMART 200 ATCC No. ______) were deposited with the American Type Culture Collection (ATCC), Manassas, Va. 20108 USA, under the terms of the Budapest Treaty on the International Recognition of the Deposit of Microorganisms for the Purpose of Patent Procedure, on ______, 2002 (received by the ATCC on May 22, 2002). Culturing and delivery methods are optimized in order to ensure the success of colonization of the microbes within the targeted waste areas, despite differing environmental and climatic conditions.

A structure is provided adjacent to the remediation site in order to culture the algae, and to provide a continual source of the microbe to remediate the waste over a long period of time. A greenhouse type structure is preferred in order to best control the particular climatic conditions thereby optimizing an environment for which to grow the culture. A desired number of production tanks (e.g., growth tanks) are placed within the greenhouse structure, and the microalgae are introduced into the production tanks for growth of the algae. The particular structure can be sized to accommodate the particular site to be remediated. Preferably, the microalgae is grown at an optimum temperature range of 70 to 90° F. The structures are built of a sufficient strength to meet typical snow and wind loads which may be encountered. The greenhouse structure is also preferably translucent on all sides to allow maximum interior sunlight for microbial growth. The production tanks receive water from either a typical municipal water supply, or from well water. The incoming water supply may be temperature controlled in order to accommodate the desired temperature in the production tanks. The greenhouse structure is also lighted, for example by mercury vapor lights, in order to provide supplemental light for algal growth and photosynthesis on overcast days or periods of short daylight hours as encountered during the winter months. In a preferred embodiment, the microalgae in the production tanks receive light for approximately 20 hours per day, accompanied by 4 hours of darkness.

Nutrients are delivered to the production tanks in order to feed the microalgae and to optimize their growth so that the algae can be delivered on a continual basis to the waste site. In 1000 gallon production tanks, the nutrients, in the form of a primary growth medium, are added at a typical rate of 5 to 15 gallons per day, dependent upon the growth rate measured within each tank. Preferably, the microalgae experience optimal growth when the water within the production tanks is maintained in a pH range from about 7.5 to 8.4, and the concentration of dissolved oxygen is maintained at between about 5 milligrams per liter and 25 milligrams per liter. Measurements are taken by onsite personnel on a daily basis using accepted industry monitoring equipment to maintain proper growth rates for the algae by monitoring the temperature, pH, hours of light verses darkness, dissolved oxygen, and any other factors which may impact the growth of the microalgae.

Conveniently, animals such as goldfish may be grown in the production tanks as a quick and reliable visual monitor of dissolved oxygen in each of the tanks, the goldfish also supplying additional nutrients to the tank water for consumption by the chlorella algae. Of course, low levels of oxygen in the water would be indicated by mortality of the goldfish.

Using the 1000 gallon production tanks, approximately 700 gallons of culture laden liquid per tank per day may be delivered to the waste site either by gravity flow or a pressurized pump system. The goal for each of the production tanks is to provide the maximum growth of the microalgae within a 24 hour period and delivery of the algae to the waste site. Preferred delivery of the culture to the waste site occurs by a continual metered flow of the liquid. For a 700 gallon delivery per day, this equates to approximately a ½ gallon per minute delivery rate. Fresh water then is added to the tank at the same rate to compensate for the lost liquid.

Nutrients may be delivered to the production tanks either manually, or through an automatic system by incorporation of a food/nutrient tank (e.g., containing primary growth medium) which meters nutrients into the production tanks. If automation is desired, the food/nutrient tank itself is either manually or automatically supplied with optimal nutrients (primary growth medium stock), along with a mix of water. The type of microalgae which are particularly advantageous for use in the present invention includes a particular strain of microalgae discovered by one of the present inventors which is believed to be of the genus Chlorella (e.g., Chlorella sp., strain rosebrookii AgSmart 100 (AG-SMART 100 ATCC No. ______) or Chlorella sp., strain rosebrookii AgSmart 200 (AG-SMART 200 ATCC No. ______)), and to progeny of these strains/species of Chlorella. This strain of microalgae has been shown by the present inventors to be extremely effective in remediation of waste because of the high amounts of oxygen which are produced by these microalgae. Furthermore, these particular microalgae have been found to adapt well to changing environmental conditions to include not only different heat and light conditions, but also to feed on a wide range of animal and human waste products. A full description of the preferred microalgae for use in the present invention, as well as a full description the optimal growth medium and culture conditions for these microalgae is found in the Assignee's copending application, U.S. patent application Ser. No. ______ by Rosebrook, filed on May 29, 2002, and entitled “Microorganism for Remediation of Waste and Method of Culturing the Same”, which is hereby incorporated by reference in its entirety. A description of the microalgae, growth medium, and culture conditions is also found in U.S. Provisional Application Serial No. 60/379,563 by Rosebrook, filed May 10, 2002, entitled “Microorganism for Remediation of Waste and Method of Culturing the Same”, also incorporated herein by reference in its entirety. Although exemplary culture and growth conditions are described herein, any of the culture and growth conditions described in the referenced provisional application and/or copending application by Rosebrook are contemplated for use in the process described herein.

Moreover, although reference is made to a particular type of microalgae for use in the system and method of the invention, it shall be understood that the system and method are not specifically limited to use of this type of microalgae. The system and method can be used in conjunction with other types of microbes, and particularly microalgae, for use in remediation of waste.

Ultimately, it is desired to achieve a critical mass of the microalgae in the waste site to produce enough oxygen to create effective remediation. In waste water holding ponds, the microalgae have shown to eliminate crust and sludge, to greatly reduce noxious orders from ammonia and hydrogen sulfides, to greatly reduce NH₃—N and BOD levels to meet local and federal permanent standards, and to maintain at least minimum dissolved oxygen concentrations at or above two milligrams per liter, as well as maintain acceptable pH levels in the treated waste. Conveniently, the culture in the production tanks can also be fed by waste from the actual waste site that is being remediated. Thus, in accordance with this invention, nutrients can be provided to the culture in the production tanks to supplement nutrients provided manually or automatically from a food tank, or the waste from the waste site itself can provide all the nutrients necessary to culture the microalgae. A pipe system and pump can be used to pump the waste from the waste site into the production tanks at a desired rate. By use of the waste site as a source for nutrients, this further simplifies and minimizes the cost of culturing the microalgae because no separate nutrient source is required.

These and other advantages will become more apparent from a review of the following drawings, taken in conjunction with the detailed description.

### BRIEF DESCRIPTION OF THE DRAWINGS

FIG. 1 is a partial fragmentary perspective view of the system of this invention incorporated within a structure which is placed adjacent to a waste site to be remediated, the figure showing the structure broken away in order to reveal processing equipment used to culture the microalgae, along with means by which the microalgae is delivered to the waste site, and also showing means by which the waste site can be used to provide nutrients to the production tanks;

FIG. 2 is a schematic diagram illustrating the system of the invention, to include the various components used within the system for remediation.

### DETAILED DESCRIPTION

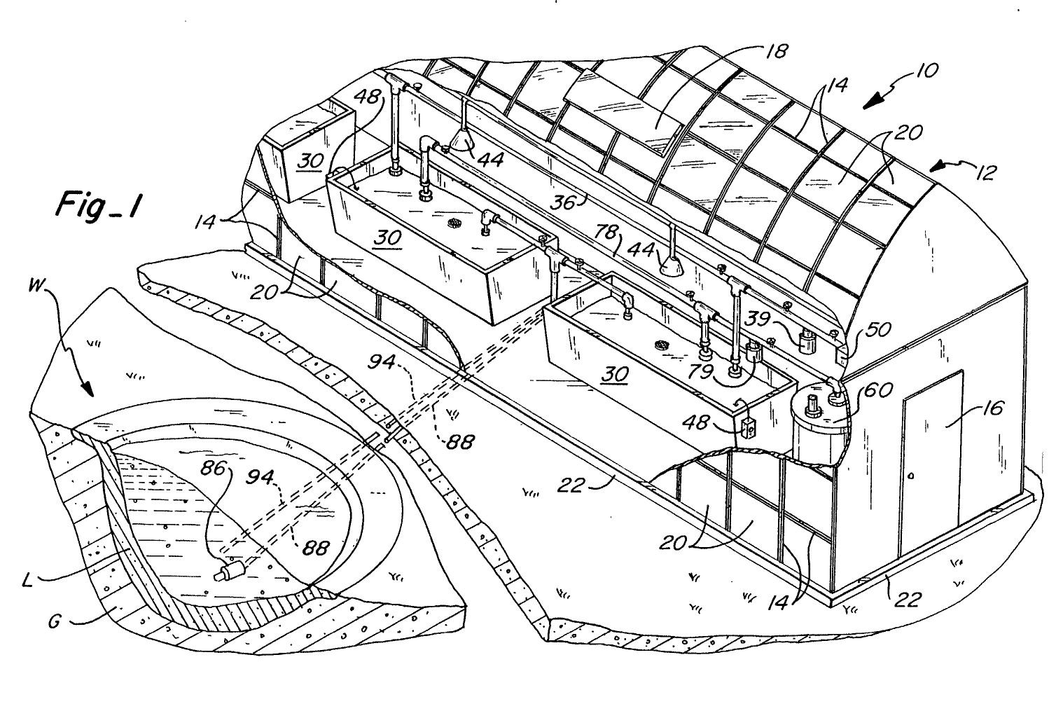

FIG. 1 illustrates the system of the current invention incorporated within a structure which houses various mechanical and electrical elements used to grow the microbial culture, and to transfer the culture to the waste site. Beginning first with the description of the system 10 with respect to the structure which houses the mechanical and electrical components, a structure 12 in the form of a greenhouse having a translucent exterior is provided at a location nearby a waste pond W or waste site which requires remediation. The structure 12 comprises a frame 14 for supporting the exterior of the structure. Frame 14 may be made of any well known construction material to include steel or wood framing materials and spaced to provide the adequate support for a plurality of window panels 20 which are mounted to the frame. One example of a suitable material for use for the panels may be 8 millimeter twin wall polycarbonate sheets. These type of panels are typically used in greenhouses. The structure 12 may be placed upon a concrete pad 22 which can be poured at a convenient location near the waste site W. Concrete anchors (not shown) can be used to attach the frame 14 to the concrete pad 22. One or more doors 16 can be provided for access to the structure. A vent 18 can be formed on the structure in order to help control the temperature within the structure. As well understood by those skilled in the art, greenhouse structures quickly heat by exposure to sunlight, even in fairly cold temperatures. The vent 18 can be controlled manually, or automatically by a damper control (not shown) which adjusts the opening of the vent. Although one vent 18 is shown, a number of additional vents may be provided as needed to provide adequate temperature control within the greenhouse. During particularly cold times, the structure 12 may be heated by any conventional means to include electrical or gas heat.

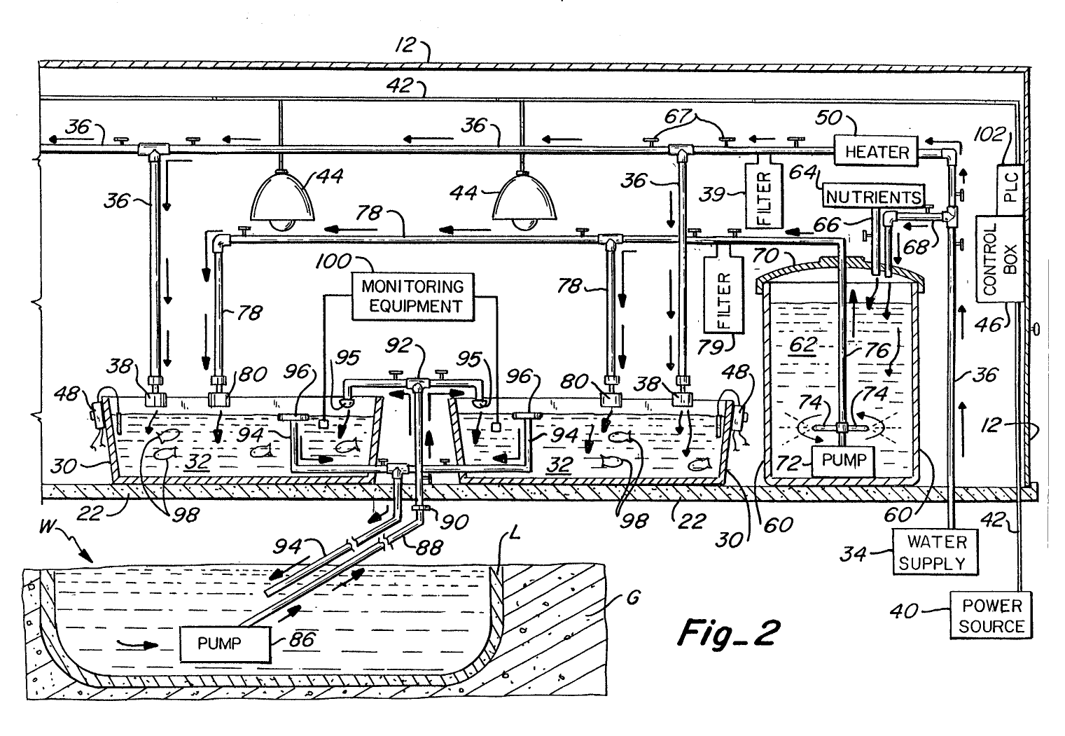

Now also referring to FIG. 2, the structure 12 illustrates a number of culture or production tanks 30 which are used to culture the microbes which are to be introduced to the waste site. The culture/production tanks are filled with water 32 which may be provided from a water supply 34, such as municipal water, or well water. A water piping system 36 is constructed to provide water to each of the culture tanks 30. Nozzles 38 of a desired orifice size may be used to allow the water 32 to be introduced within the tanks at a desired rate. Upstream of the nozzles 38, a water filter 39 can be provided to filter the water from many potentially undesirable contaminants. For example, if municipal waste water is used, it may be desirable to limit the amount of chlorine which may be present in the municipal waste water. Although chlorine within normal municipal water limits is not unduly harmful to the microbial culture, use of filter 39 provides flexibility in filtering not only chlorine, but any other contaminants that might be present, to include undesirable minerals.

A power source 40 is provided to run the various mechanical and electrical devices within the structure. Lamps 44 are positioned over the tanks 30 to provide additional hours of light to the culture tanks, especially during overcast days and during the months of winter. As discussed above, it is generally preferable to have approximately 20 hours of light exposure for the culture in order to maximize its growth. Mercury vapor lights are but one example the type of lights which may be used within the structure. Generally, it is desirable to provide an artificial light source which most closely matches the spectrum of light provided by the sun, to include ultraviolet light. A control box 46 may be mounted at any convenient location within the structure to provide the various switches and controls for manipulating the mechanical and electrical equipment within the structure. Each of the culture tanks may be equipped with thermostats 48 which measure the temperature of the water. If necessary, the incoming water may be heated by inline heater 50. Inline heater 50 may be an electrical coil type heater which effectively raises the temperature of the incoming water. Because the optimum temperature range for growth of the microbes is between about 70 to 90° F., it would be quite unusual to encounter a circumstance when the water temperature in the tanks would be maintained above 90° F. for any appreciable amount of time. Therefore, it would not normally be necessary to provide some means to cool the water within the culture tanks. Nonetheless, the invention also contemplates the capability to cool the water in the tanks by providing an inline cooling device, (not shown) which would cool the water prior to entering the tanks. Such a device could be mounted adjacent to the heater 50.

Nutrients can be introduced into the tanks 30 either manually, or through a more automated means. As shown in FIG. 2, a nutrient storage tank 60 may be situated adjacent the production tanks, and nutrient delivery lines 78 can interconnect tank 60 to the production tanks 30. Nutrients 64 may be introduced into the tank via line 66. The nutrients 64 would then be mixed within the storage tank 60 along with water which is supplied through water inlet 68. A removable top 70 allows access to the interior of the tank 60 for cleaning or maintenance. Accordingly, the lines 66, 68 and 78 can be disconnected as required for cleaning access to the tank 60. Any number of shutoff valves 67 can be provided in both the water and nutrient lines to allow repair or replacement of the lines or components placed in line with the lines. To prevent undue settling of solids within the tank 60, a series of jets 74 mounted on an internal delivery line 76 may be used to keep the nutrients well mixed within the tank. Pump 72 can be used to provide the power for jets 74, as well as to transfer the nutrient mixture to the culture tanks through internal delivery line 76 which connects to delivery lines 78. Thus, line 76 provides not only a means for mounting the jet 74, but also provides a line within the tank communicating with line 78 for transfer of the nutrient mixture. An inline filter 79 can also be provided to filter out undesirable components in the nutrient mixture, such as unduly large solids. Nozzles 80 may also be provided to meter the nutrient mixture into the tanks at the desired rate. For both the water lines 36 and the nutrient mixture lines 78, the necessary back pressure is required to insure that the nozzles deliver the water and nutrient mixture at the designed rates through the respective nozzles.

During startup, the tanks 30 would be filled, and the microbes would be placed manually into the tanks. Then, the nutrients (e.g., primary growth medium) would be delivered to the tanks to allow the microbes to begin to grow. Once the desired level of growth had occurred within the tanks 30, the tanks can then be emptied at a desired rate to deliver the microbes to the waste site W. The loss of liquid within the tanks by delivery of the culture to the waste site is then compensated by additional water and nutrients added to the culture tanks. Accordingly, the production tanks 30 are kept at a steady state wherein there is continual flow through the tanks, and the microbes continue to grow in the tanks. The culture delivery lines 94 conveys the culture laden liquid to the waste site. Preferably, the structure 12 is situated at an elevation which is higher than the waste site W so that gravity flow may be used for delivering the microbes to the waste site. Floats 96 can be provided to prevent the tanks from overflowing, and to meter the release of culture laden liquid into lines 94.

As a supplemental nutrient source, or even as a primary nutrient source, waste within the waste site W may be pumped to the production tanks. In some circumstances, the waste site W may by itself provide the required nutrients that allows the culture to grow at the desired rate, without any additional nutrients being provided from an outside source. Accordingly, a pump 86 may be situated directly within the waste site, and line 88 may deliver the waste to the culture tanks for use as nutrients to feed the culture. A filter 90 can also be provided to filter solids and other undesirable components which may be pumped from the waste site. A simple distribution unit 92 which communicates with line 88 may be used for direct delivery of the waste/nutrients to the tanks. Delivery unit 92 may also include respective nozzles 95 which meter the waste/nutrients into the tanks. If the waste site W is located at a elevation higher than the tanks, then a pump (not shown) could be installed on line 94 for delivery of the culture laden liquid. Typically, a waste site requires a liner L to prevent the waste from seeping into and thus contaminating the ground G.

Oxygen levels within the production tanks 30 can be monitored by placing fish 98, such as goldfish, within the tanks. Goldfish are very sensitive to oxygen levels, and can serve as a quick check for proper oxygenation levels in the production tanks. Dead fish would presumably indicate a low level of oxygen and therefor poor growth of the culture. In addition to temperature monitoring of the tanks and visual oxygenation checks by use of the fish, the tanks may also be monitored daily to insure correct pH and to actually measure dissolved oxygen levels. Standard WSI instruments may be used for monitoring these parameters.

The system can be automated to the desired extent, depending upon the size of the site to be remediated, and other factors. For example, for an extremely large waste site, it may be necessary for more hands-on observation of the system to ensure proper growth of the microbial culture and delivery to the waste site. However, it is contemplated within the spirit and scope of this invention to provide a system whereby minimal interference is necessary to maintain a continual culture growth and delivery of culture to the waste site. For example, a programmable logic controller (PLC) or other computer means may be incorporated to provide automation. The various measurements which are taken to check the status of the culture can be input to the PLC. The PLC can then generate various outputs for control of the system. For example, the thermostats 48 mounted on or near the tanks would be one example of an input to a PLC, while activation of the heater would represent an output responsive to commands by the PLC for heating the tanks. Light, pH control, as well as dissolved oxygen could also be automatically monitored by measurement devices communicating with the tanks. A PLC could process these inputs and then provide outputs to vary or adjust these parameters. In another example, the PLC could control a valve which allows introduction of a chemical into the tanks for adjustment of the PH in response to an out of limit PH condition. Another example of PLC control might include automatic delivery of nutrients to the tanks 30 by activation of pump 72 in response to low levels of measured nutrients in the tanks 30.

FIG. 2 also shows that monitoring equipment 100 may be used to monitor the status of the production tanks. For example, the monitoring equipment could include industry accepted oxygen monitoring devices, devices used for measuring PH levels in the tanks, or other measuring devices to measure various other parameters of the culture laden liquid within the tanks 30. The results of the monitoring efforts can be then addressed by manual intervention to correct problems, or by automatic intervention by the PLC. For automated responses, the results of the monitoring efforts can be used as inputs to a PLC 102 shown mounted adjacent the control box 46. The PLC 102 can actually be incorporated within the control box 46, as understood by those skilled in the art.

The following examples are provided illustrating the both the system and method of this invention in practice:

### EXAMPLE 1

Pond #1 is 100′×225′×12′ with a capacity of 6 acre feet. Four swine confinement buildings (slatted floor, pull pit), with a total one time capacity of 3,600 head, drain into this receiving pond on a weekly basis. The average BOD concentration of the waste stream is 18,900 mg/L, the NH3-N measurement is 1,280 mg/L, and the concentrated dissolved oxygen is 0.06 mg/L. The surface area prior to treatment was completely crusted and thick enough (18-24″) to allow a person to walk across. The bottom sludge had built up to a depth of 8′ with free flowing liquid depth of 2-2.5′ under the crust. Maintaining a continuing flow from the discharge point into the next settling pond became a weekly maintenance issue due to the heavy crust and sludge buildup.

Post treatment results after the daily delivery of the microalgal culture, denoted Chlorella sp., strain rosebrookii AgSmart 100 (AG-SMART 100 ATCC No. ______) and/or progeny thereof, into waste pond #1 were dramatic. Within 12 months, the surface was over 95% free of crust. The bottom sludge has been reduced to a soft slurry that continues to break down; and, there is over 8′ of free flowing liquid. The discharge outlet is open and does not require attention from on site labor. The outlet wastewater stream into the next holding pond demonstrates a 50% reduction of BOD and NH3-N concentrations with dissolved oxygen readings greater than 2.0 mg/L. A boat can now be used to measure bottom slurry levels and obtain grab samples of pond wastewater from various locations. The pre and post treatment samples were analyzed and reported by a state certified laboratory. Dissolved oxygen readings were obtained using accepted wastewater industry monitoring equipment by on site personnel. The remediation of this pond from an organically burdened anaerobic status to an open, free flowing, odorless aerobic status has taken place during all climatic conditions (−10 degrees F. to 100 degrees F.) over a 12 months treatment period.

### EXAMPLE 2

Pond #3 is 80′×320′×15′ with a capacity of 9 acre feet. Four swine confinement buildings (flush gutter), with a total one time capacity of 3,600 head, drain into this receiving pond on a daily basis. The pond has been mechanically cleaned twice since 1970 to remove all the organic sludge that clogged the pond. The daily BOD load is approximately 30,000 mg/L, the NH3-N is 650 mg./L, and the dissolved oxygen concentration is ≦0.05 mg/L.

Prior to treatment, the surface area was completely crusted and would not permit a boat to be used for grab samples anywhere on the pond. The outlet discharge point to the next holding pond had to be relocated 200′ closer to the inlet receiving point due to sludge and crust buildup that prevented free flow to the original outlet point. After 8 months of daily treatment of the microalga, denoted Chlorella sp., strain rosebrookii AgSmart 100 (AG-SMART 100 ATCC No. ______) and/or progeny thereof, which included the four winter months of November, December, January, and February, the surface area crust has been reduced by 50%. The farthest, original discharge outlet into the next holding pond has opened to allow free flow of liquid. Bottom digestion indicated by “surface bubbling” and free floating material has been observed daily, even during cold winter periods. Dissolved oxygen concentrations of ≦1.2 mg/L have been measured at the outlet points and in the open surface areas. Grab samples for continuing analysis can be obtained with a boat by on site personnel. Pre and post wastewater samples were analyzed and reported by a state certified laboratory. Dissolved oxygen readings were obtained using accepted wastewater industry monitoring equipment by on site personnel. Within the 12 month treatment protocol, this receiving pond has changed from an anaerobic to an aerobic status.

The advantages of the current invention are clear. A simple structure may be provided for controlling environmental conditions. Processing equipment used to support growing of the culture is also simple, and can easily be housed within a modest sized structure. Once the system has achieved equilibrium after startup, minimum intervention is required to keep the system running efficiently. A continual supply of culture can be transferred to the waste site for extended periods of remediation. The aerobic treatment of the waste provides an environmentally friendly solution as compared to nonaerobic processes. The particular species/strain of microalgae, Chlorella sp., strain rosebrookii AgSmart 100 (AG-SMART 100 ATCC No. ______), progeny strain Chlorella sp., strain rosebrookii AgSmart 200 (AG-SMART 200 ATCC No. ______), and other progeny thereof, are aggressive growing microorganisms that produce high amounts of oxygen. The system is flexible in design because it may be sized to accommodate the waste site to be treated. The system is also flexible in terms of the extent to which it may be desired to automate control of the system.

The invention has been described with reference to a preferred embodiment herein; however, it shall be understood that various modifications can be made within the spirit and scope of the invention.

What is claimed is:

1. A system for remediating waste, such as animal waste produced from agricultural operations, said system comprising:
a structure having an exterior made of translucent material allowing sunlight to pass therethrough;
at least one production tank positioned within the structure, said production tank having a predetermined volume of water therein set at a desired temperature range;
means for delivering nutrients to the tank for nourishing a culture of microorganisms placed in the tank for culturing;
means communicating with the tank for monitoring the temperature of the water; and
means communicating with the production tank for delivering the culture to a waste site for remediation of the waste site.

2. A system, as claimed in claim 1, wherein:
said structure includes at least one vent for controlling the temperature within the structure.

3. A system, as claimed in claim 1, wherein:
said structure is in the form of a greenhouse.

4. A system, as claimed in claim 1, wherein:
said system further includes means communicating with the tank for monitoring oxygen levels in said tank to determine if the culture is metabolizing at desired levels.

5. A system, as claimed in claim 1, wherein:
said means for delivering nutrients includes at least one pipeline, and a nozzle communicating with the pipeline to meter flow of the nutrients into said at least one production tank.

6. A system, as claimed in claim 1, further including:
means for delivering water to the tank from a water supply, said means for delivering water further including a temperature controller placed in line with the water supply for controlling the temperature of the water supplied to the at least one production tank.

7. A system, as claimed in claim 1, further including:
fish placed in the at least one production tank to provide a visual monitor of dissolved oxygen within the tank.

8. A system, as claimed in claim 1, further including:
an artificial light source placed within the structure to provide additional light as required for optimum growth of the culture.

9. A system, as claimed in claim 1, wherein:
said culture is a microalgae.

10. A system, as claimed in claim 1, wherein:
said culture is a microalgae of the genus Chlorella.

11. A system, as claimed in claim 1, wherein:
said culture is a microalgal strain selected from the group consisting of:
a) Chlorella sp., strain rosebrookii AgSmart 100 (AG-SMART 100 ATCC No. ______);
b) Chlorella sp., strain rosebrookii AgSmart 200 (AG-SMART 200 ATCC No. ______); and
c) progeny derived from either of said microalgal strains of (a) or (b).

12. A system, as claimed in claim 1, wherein:
said culture produces high amounts of oxygen used to remediate the waste through an aerobic process.

13. A method of remediating waste, such as animal waste produced from agricultural operations, said method incorporated within a system of remediation, said method comprising the steps of:
providing at least one production tank with water therein set at a desired temperature range;
introducing a microbial culture into said production tank;
introducing food/nutrients into the production tank for growing the culture;
controlling heat conditions so that the culture grows at a desired rate within the culture tank;
controlling light conditions to optimize growth of the culture within the tank;
monitoring oxygen levels within the tank for optimizing growth of the culture;
delivering the culture through a delivery line to a waste site to be remediated, said production tank being placed adjacent the waste site at a convenient location;
continuing to replenish water and nutrients in the culture tank thereby maintaining a viable population of the microorganisms within the culture tank;
continuing to deliver the culture through the pipeline to the waste site at a desired steady rate according to the remediation requirements for the waste site and the capacity of the production tank; and
producing aerobic remediation within the waste site by interaction of the culture which consumes the waste and produces oxygen.

14. A method, as claimed in claim 13, further comprising the step of:
providing a translucent structure housing the at least one production tank thereby assisting in temperature control of the tank.

15. A method, as claimed in claim 13, wherein:
said culture is a microalgae.

16. A method, as claimed in claim 13, wherein:
said culture is a microalgae of the genus Chlorella.

17. A method, as claimed in claim 13, wherein:
said culture is a microalgal strain selected from the group consisting of:
a) Chlorella sp., strain rosebrookii AgSmart 100 (AG-SMART 100 ATCC No. ______);
b) Chlorella sp., strain rosebrookii AgSmart 200 (AG-SMART 200 ATCC No. ______); and
c) progeny derived from either of said microalgal strains of (a) or (b).

18. A method, as claimed in claim 13, wherein:
said second introducing step is achieved by introducing waste from the waste site into the production tank at metered amounts to optimize growth of the culture.

19. A method, as claimed in claim 13, wherein:
said waste from the waste site is delivered to the production tanks as by a pipe interconnecting the waste site and the production tank.

20. A method, as claimed in claim 13, wherein:
said second introducing step, said controlling steps, and said monitoring step are controlled by a programmable logic controller which receives inputs from parameters of the system to include a measure of nutrients in the production tank, the temperature of the production tank, the oxygen level within the production tank, and the number of hours of light to which the production tanks are exposed, said PLC then producing parameter outputs to maintain the system for optimal growth conditions of the culture.

21. A method, as claimed in claim 13, wherein:
said delivering step occurs by gravity flow of the culture to the waste site.

22. A method, as claimed in claim 13, wherein:
said delivering step occurs by pumping the culture to the waste site.

23. A system for remediating waste, such as animal waste produced from agricultural operations, said system comprising:
a structure having an exterior made of translucent material allowing sunlight to pass therethrough, said structure including at least one opening formed therein for controlling the temperature within the structure;
at least one production tank positioned within the structure, said production tank having a predetermined volume of water therein and set at a desired temperature range;
a nutrient tank for holding nutrients to be supplied to the at least one production tank, said nutrient tank including a pump positioned therein for delivering nutrients to the production tank;
means for delivering water to the at least one production tank, said means for delivering including an inline heater for heating the water delivered to the production tank in order to maintain the water in the tank at the desired temperature range;
a microorganism placed in the production tank, said microorganism comprising a remediating culture to be delivered to the waste site for remediation of the waste site wherein the production tank and the nutrients delivered thereto provide a medium for growth and colonization of the microorganism;
means communicating with the production tank for delivering the culture to the waste site; and
an artificial light source placed within the structure to provide additional light as required for optimum growth of the culture.

24. A system, as claimed in claim 23, wherein:
said structure is in the form of a greenhouse.

25. A system, as claimed in claim 23, wherein:
said system further includes means communicating with the at least one production tank for monitoring oxygen levels in said at least one production tank to determine if the culture is metabolizing at desired levels.

26. A system, as claimed in claim 23, further including:
fish placed in the at least one production tank to provide a visual monitor of dissolved oxygen within the tank.

27. A system, as claimed in claim 23, wherein:
said culture is a microalgae of the genus Chlorella.

28. A system, as claimed in claim 23, wherein:
said culture is a microalgal strain selected from the group consisting of:
a) Chlorella sp., strain rosebrookii AgSmart 100 (AG-SMART 100 ATCC No. ______);
b) Chlorella sp., strain rosebrookii AgSmart 200 (AG-SMART 200 ATCC No. ______); and
c) progeny derived from either of said microalgal strains of (a) or (b).

29. A system, as claimed in claim 23, wherein:
said culture produces high amounts of oxygen used to remediate the waste through an aerobic process.

30. A system, as claimed in claim 23, further including:
means mounted in said nutrient tank for agitating nutrients in said nutrient tank to prevent settling and separation of the nutrients.
